(19) United States
(12) Patent Application Publication
(10) Pub. No.: US 2025/0295543 A1
(43) Pub. Date: Sep. 25, 2025

(54) CONTINUAL MOTION CHAIR APPARATUS FOR THERAPEUTIC BLOOD AND VASCULAR CIRCULATION

(71) Applicant: Eldon Bullen, Reform, AL (US)

(72) Inventor: Eldon Bullen, Reform, AL (US)

(21) Appl. No.: 19/064,995

(22) Filed: Feb. 27, 2025

Related U.S. Application Data
(60) Provisional application No. 63/568,255, filed on Mar. 21, 2024.

(51) Int. Cl. A61H 1/00

(52) U.S. Cl. CPC A61H 1/001; A61H 2201/0149; A61H 2201/1623; A61H 2201/164; A61H 2201/503; A61H 2203/0431; A61H 2203/0437; A61H 2203/0456

(57) ABSTRACT

A therapeutic chair apparatus designed to enhance blood and vascular circulation through continual motion is disclosed. The described apparatus addresses the technical problem of insufficient therapeutic benefits in existing furniture by providing a programmable control unit that initiates and terminates continuous repositioning of a reclining chair. This repositioning adjusts the leg, torso, and shoulder positions over an extended period, thereby improving circulation. The apparatus includes a start button and a stop button for user control and is electrically coupled to the chair to facilitate motion. The primary use of this apparatus is in therapeutic settings where enhanced circulation is desired. The method involves actuating the start button to begin motion and the stop button to end the motion, providing a comprehensive physical therapy experience. This solution offers a significant improvement over static or limited-motion devices, ensuring sustained therapeutic benefits.

### CROSS REFERENCE TO RELATED APPLICATION

This application claims the benefit of priority of U.S. provisional application No. 63/568,255, filed Mar. 21, 2024, the contents of which are herein incorporated by reference.

### BACKGROUND OF THE SUBJECT DISCLOSURE

The present disclosure relates to therapeutic furniture, specifically to a chair designed for continual motion to improve blood and vascular circulation through programmable movement, which is selectable to be consistent of intermittent.

In physical therapy, physiotherapy, fitness and conditioning regimes, and the like improving one's cardiovascular system is a critical goal, and so there is a growing demand for solutions that provide effective physical benefits through continuous movement. However, individuals who are sedentary, bed-ridden or otherwise incapable of moving their body parts sufficiently to reap the attendant cardiovascular gain there is a need for physical assistance for such movements by way of a device they can be seated in or laying down on.

Existing devices often fall short, as they typically involve a supporting device that offers limited movement, such as simple vibration or static repositioning, which do not adequately address the need for comprehensive physical therapy. These devices often lack the ability to provide a full-body therapeutic experience, which is necessary for improving blood circulation.

Current solutions are further constrained by their design and programming, resulting in minimal therapeutic benefits. They often move to a single position and then stop, failing to deliver the sustained motion necessary for significant physical therapy. This limitation highlights the need for an innovative approach that can offer programmable motion, ranging from continuous to intermittent, to enhance and selectively hone the therapeutic experience, thereby addressing the shortcomings of existing devices and providing a more effective solution for users seeking improved circulation and overall physical well-being.

As can be seen, there is a need for a mechanical engineering application involving a continual motion chair designed to enhance blood and vascular circulation through programmable movement.

### SUMMARY OF THE SUBJECT DISCLOSURE

In one aspect of the subject disclosure, a method for providing continual therapeutic motion to enhance blood and vascular circulation includes the following: providing a reclining chair; electrically coupling the reclining chair to a programmable control unit including a start button and a stop button; actuating the start button to initiate continual motion of the reclining chair; continuously repositioning the reclining chair to adjust leg, torso and shoulder positions over an extended period; and actuating the stop button to terminate the continual motion.

In another aspect of the subject disclosure, an apparatus for providing continual therapeutic motion to enhance blood and vascular circulation, includes the following: a reclining chair; a programmable control unit electrically coupled to the reclining chair, the programmable control unit including a start button and a stop button; and an electrical connection operatively coupling the reclining chair to the programmable control unit, wherein actuation of the start button initiates continual motion of the reclining chair for continuously repositioning the leg, torso and shoulder positions over an extended period, and wherein actuation of the stop button terminates the continual motion.

In yet another aspect of the subject disclosure a method for providing continual therapeutic motion to enhance blood and vascular circulation including the following: providing a multi-positional chair configured to move between a plurality of reclining positions by way of an actuator; electrically coupling the actuator to a programmable control unit; and continuously repositioning the multi-positional chair by activating the programmable control unit, whereby a user seated in the multi-positional chair has their torso urged in different positions as the multi-positional chair cycles through the plurality of reclining positions, wherein the plurality of reclining positions comprises a supine reclined position, a seated position, a partial reclined position wherein a backrest tilts backward while a footrest remains lowered, and a forward tilted position, wherein the backrest tilts forward more than fifteen degrees relative to the seated position, wherein the cycling is continuous for a period or wherein the cycling is intermittent for a period, and wherein a pause of a predetermined time happens between each sequential reclining position; and further electrically coupling the programmable control unit to a start button and a stop button; activating the start button to initiate continual motion of the multi-positional chair; and activating the stop button to terminate the continual motion.

These and other features, aspects and advantages of the present subject disclosure will become better understood with reference to the following drawings, description and claims.

### BRIEF DESCRIPTION OF THE DRAWINGS

FIG. 1 is a schematic view of an exemplary embodiment of the subject disclosure.

FIG. 2 is a flow chart of an exemplary embodiment of the subject disclosure.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

Broadly, an embodiment of the present subject disclosure provides a method of providing physical therapy and fitness condition embodied in a continual motion chair designed to enhance blood and vascular circulation through continual motion of the user seated therein. Unlike existing devices, this apparatus offers a programmable control unit that initiates and terminates continuous repositioning of a reclining chair, whereby the movement can be continuous or intermittent depending on the therapeutic objectives and treatment plans. This device-urged repositioning can be programmed to selectively adjust the leg, torso, and shoulder positions or positions of other body parts that are engaging the device. Operation of the systemic device may be programmed to be constant or intermittent over an extended period, thereby selectively improving circulation depending on the user's needs. The apparatus may include a start button and a stop button for user control and is electrically coupled to the chair to facilitate motion. The start and stop buttons along with other positioning, timing, and rate-related triggers may be embodied in a remote control. The primary use of this apparatus is in therapeutic settings where enhanced circulation is desired. This solution offers significant improvement over static or limited-motion devices, ensuring sustained therapeutic benefits and a comprehensive physical therapy experience.

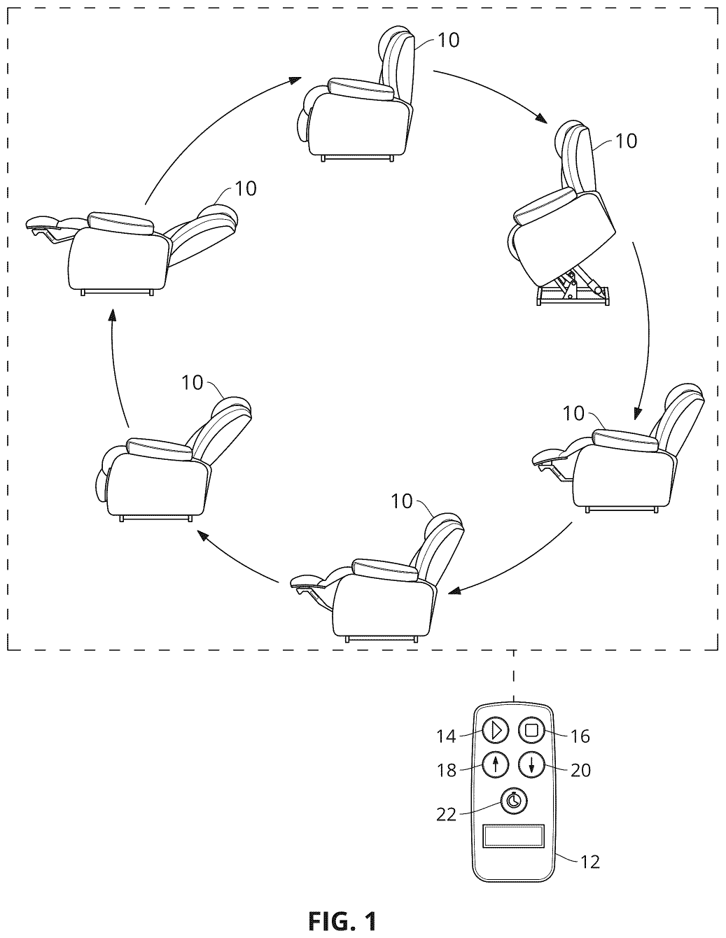

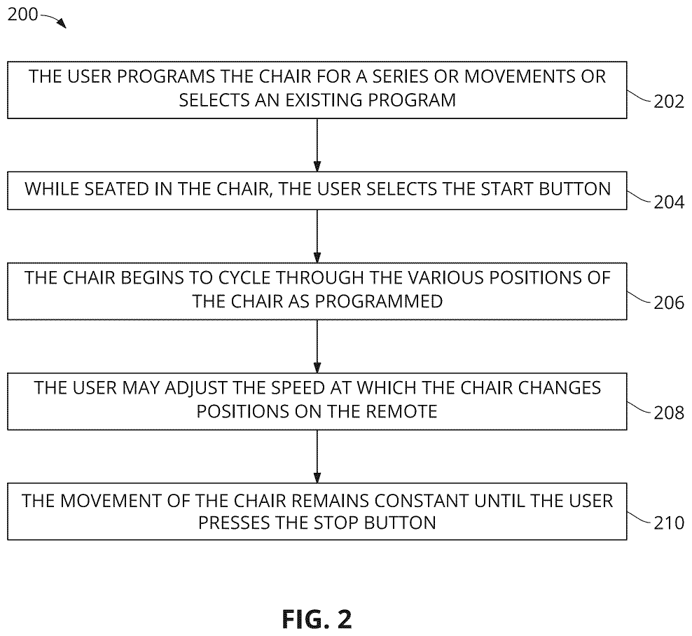

Referring to FIGS. 1 and 2, the subject disclosure may include a multi-positional chair 10 operatively associated with a remote 12 with a start button 14, a stop button 16, a raise speed button 18, a lower speed button 20, and a timer control 22. It is understood that the remote 12 may be a handheld device or embodied in software or integrated into the multi-positional chair 10.

A routine for a user of the multi-positional chair 10 may include the following: the user programs the chair for a series of movements or selects an existing program, in step 202, While seated in the multi-positional chair 10, the user selects the start button 12, in step 204. Then the multi-positional chair 10 begins to cycle through the various positions of the multi-positional chair 10, as programmed in step 206. Then, in step 208, the user may adjust the speed at which the multi-positional chair 10 changes position on the remote 10. The movement of the multi-positional chair 10 can remain constant until the user presses the stop button 16; alternatively, the change of position may be intermittent.

The timer control 22 enables the user to select the length of the continuous change of positions as well as set the periods of inactivity during an intermittent phase. The positions of the multi-positional chair 10 include all those shown in FIG. 1, as well as all other known positions multi-positional chairs are capable of being actuated into and out of.

The multi-positional chair 10 can be used by individuals who cannot walk to help with sedentary conditions. It can also be used by healthy individuals who may be experiencing a little muscle soreness in need of lite exercise.

The multi-positional chair 10 enables the user the remain in the same place in a room, since the multi-positional chair 10 does not move across the supporting surface (floor) but rather cycles through the actuated positions shown in FIG. 1.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A method for providing continual therapeutic motion to enhance blood and vascular circulation, comprising:
providing a multi-positional chair configured to move between a plurality of reclining positions by way of an actuator;
electrically coupling the actuator to a programmable control unit; and
continuously repositioning the multi-positional chair by activating the programmable control unit, whereby a user seated in the multi-positional chair has their torso urged in different positions as the multi-positional chair cycles through the plurality of reclining positions.

2. The method of claim 1, wherein the plurality of reclining positions comprises a supine reclined position, a seated position, a partial reclined position wherein a backrest tilts backward while a footrest remains lowered, and a forward tilted position, wherein the backrest tilts forward more than fifteen degrees relative to the seated position.

3. The method of claim 2, wherein the cycling is continuous for a period.

4. The method of claim 2, wherein the cycling is intermittent for a period, wherein a pause of a predetermined time happens between each sequential reclining position.

5. The method of claim 2, further electrically coupling the programmable control unit to a start button and a stop button; activating the start button to initiate continual motion of the multi-positional chair; and activating the stop button to terminate the continual motion.

6. An apparatus for providing continual therapeutic motion to enhance blood and vascular circulation, comprising:
a multi-positional chair configured to move between a plurality of reclining positions by way of an actuator;
a programmable control unit electrically coupled to the multi-positional chair, the programmable control unit including a start button and a stop button; and
an electrical connection operatively coupling the multi-positional chair to the programmable control unit, wherein actuation of the start button initiates continual motion of the reclining chair for continuously repositioning the leg, torso and shoulder positions over an extended period, and wherein actuation of the stop button terminates the continual motion.
